(19) United States
(12) Patent Application Publication
(10) Pub. No.: US 2023/0036756 A1
(43) Pub. Date: Feb. 2, 2023

(54) TRAVEL SUPPORT CONTROL DEVICE FOR HYBRID VEHICLE

(71) Applicant: TOYOTA JIDOSHA KABUSHIKI KAISHA, Toyota-shi (JP)

(72) Inventor: Yuki OGAWA, Toyota-shi (JP)

(73) Assignee: TOYOTA JIDOSHA KABUSHIKI KAISHA, Toyota-shi (JP)

(21) Appl. No.: 17/865,534

(22) Filed: Jul. 15, 2022

(30) Foreign Application Priority Data
Jul. 29, 2021 (JP) 2021-124309

(51) Int. Cl. B60W 20/12; B60W 40/02; B60W 10/26; B60W 50/00; B60L 58/13

(52) U.S. Cl. CPC B60W 20/12; B60W 40/02; B60W 10/26; B60W 50/0097; B60W 50/0098; B60L 58/13; B60W 2552/15; B60W 2554/406; B60L 2240/642; B60L 2240/68; B60L 2260/54

(57) ABSTRACT

When an adjustment target road in which a state of charge of the battery needs to be actively adjusted such as a congested road or a downhill road has been detected in the travel route based on the look-ahead information, the travel support control device performs state-of-charge adjustment control up to the adjustment target road. The travel support control device detects the adjustment target road based on look-ahead information generated for an estimated route on which it is estimated that the hybrid vehicle is to travel when the travel route has not been set, and performs the state-of-charge adjustment control up to the adjustment target road when the adjustment target road has been detected. At this time, a detection range for detecting a congested road and a detection range for detecting a downhill road in the estimated route are different.

### CROSS-REFERENCE TO RELATED APPLICATION

This application claims priority to Japanese Patent Application No. 2021-124309 filed on Jul. 29, 2021, incorporated herein by reference in its entirety.

### BACKGROUND

### 1. Technical Field

The disclosure relates to a travel support control device for a hybrid vehicle and, more particularly, to a travel support control device for a hybrid vehicle that creates a travel support plan in which travel modes are assigned to a travel route to allow the hybrid vehicle to travel.

### 2. Description of Related Art

In the related art, a travel support control device that extracts a section corresponding to a congested road or a downhill road in a travel route from a current location to a destination was proposed as such a type of travel support control device for a hybrid vehicle (for example, see Japanese Unexamined Patent Application Publication No. 2011-6047 (JP 2011-6047 A)). In this device, when a section corresponding to a congested road or a downhill road is extracted, a state of charge SOC (a start SOC) of a battery at a start point of each section is determined and control is performed such that the state of charge SOC of the battery at the start point of each section reaches the start SOC. As a result, an improvement in fuel efficiency of a hybrid vehicle is achieved.

### SUMMARY

However, in the hybrid vehicle, when a travel route from a current location to a destination is not set, a congested road or a downhill road cannot be extracted. When a travel route is not set, a travel route may be estimated to a certain extent, but execution of control may cause a driver to feel discomfort when such control is performed on a congested road or a downhill road extracted in the estimated travel route but the hybrid vehicle does not travel along the estimated travel route.

The disclosure provides a travel support control device for a hybrid vehicle that can perform more appropriate control on a congested road or a downhill road in an estimated route on which it is estimated that a hybrid vehicle is to travel.

A travel support control device for a hybrid vehicle according to the disclosure employs the following configurations.

A travel support control device for a hybrid vehicle according to a first aspect of the disclosure is a travel support control device for a hybrid vehicle including an engine, a motor, a battery, and a navigation system that performs route guidance for a travel route from a current location to a destination, the travel support control device performing state-of-charge adjustment control up to an adjustment target road in which a state of charge of the battery needs to be actively adjusted such as a congested road or a downhill road when the adjustment target road has been detected in the travel route based on look-ahead information generated for the travel route, wherein the travel support control device is configured to detect the adjustment target road based on look-ahead information generated for an estimated route on which it is estimated that the hybrid vehicle is to travel when the travel route has not been set and to perform the state-of-charge adjustment control up to the adjustment target road when the adjustment target road has been detected, and wherein a detection range for detecting a congested road and a detection range for detecting a downhill road in the estimated route are different.

In the travel support control device for a hybrid vehicle according to the first aspect of the disclosure, when an adjustment target road in which a state of charge of the battery needs to be actively adjusted such as a congested road or a downhill road has been detected in the travel route, state-of-charge adjustment control is performed up to the adjustment target road based on look-ahead information generated for the travel route from the current location to the destination. The state-of-charge adjustment control is control in which the state of charge SOC of the battery is increased to a start point of a congested road when the congested road has been detected as the adjustment target road and is control in which the state of charge SOC of the battery is decreased to a start point of a downhill road when the downhill road has been detected as the adjustment target road. An adjustment target road is detected based on look-ahead information generated for an estimated route on which it is estimated that the hybrid vehicle is to travel when a travel route has not been set, and state-of-charge adjustment control is performed up to the adjustment target road when the adjustment target road has been detected. At this time, the detection range for detecting a congested road and the detection range for detecting a downhill road in the estimated route are different. Accordingly, it is possible to set a detection range corresponding to road conditions (a congested road or a downhill road) in the estimated route and to more appropriately perform state-of-charge adjustment control when an adjustment target road has been detected. As a result, it is possible to perform more appropriate control for a congested road or a downhill road in the estimated route. The look-ahead information may be generated by the navigation system or may be generated by the travel support control device.

In the travel support control device for a hybrid vehicle according to the first aspect of the disclosure, the detection range for detecting a congested road in the estimated route may be narrower than the detection range for detecting a downhill road in the estimated route. When a congested road has been detected as the adjustment target road, control for increasing the state of charge SOC of the battery up to a start point of the congested road is performed as the state-of-charge adjustment control. Since a driver can see congestion using a screen of the navigation system or the like, a feeling of discomfort due to execution of the state-of-charge adjustment control may be given to the driver when detection of a congested road in the estimated route is not appropriate (for example, when the hybrid vehicle is not traveling on the congested road), but it is possible to reduce a degree of discomfort given to the driver due to execution of the state-of-charge adjustment control by narrowing the detection range of a congested road in the estimated route.

In the travel support control device for a hybrid vehicle according to the first aspect of the disclosure, a target state of charge of the battery at a start point of a congested road in the state-of-charge adjustment control for the congested road detected in the estimated route may be different from the target state of charge of the battery at the start point of a congested road in the state-of-charge adjustment control for the congested road detected in the travel route. In this case, the target state of charge of the battery at the start point of a congested road in the state-of-charge adjustment control for the congested road detected in the estimated route may be less than the target state of charge of the battery at the start point of a congested road in the state-of-charge adjustment control for the congested road detected in the travel route. With this configuration, it is possible to perform control corresponding to a congested road detected in the travel route or a congested road detected in the estimated route.

A travel support control device for a hybrid vehicle according to a second aspect of the disclosure is a travel support control device for a hybrid vehicle including an engine, a motor, a battery, and a navigation system that performs route guidance for a travel route from a current location to a destination, the travel support control device performing state-of-charge adjustment control up to an adjustment target road in which a state of charge of the battery needs to be actively adjusted such as a congested road or a downhill road when the adjustment target road has been detected in the travel route based on look-ahead information generated for the travel route, wherein the travel support control device is configured to detect the adjustment target road based on look-ahead information generated for an estimated route on which it is estimated that the hybrid vehicle is to travel when the travel route has not been set and to perform the state-of-charge adjustment control up to the adjustment target road when the adjustment target road has been detected, and wherein a target state of charge of the battery at a start point of a congested road in the state-of-charge adjustment control for the congested road detected in the estimated route is different from the target state of charge of the battery at the start point of a congested road in the state-of-charge adjustment control for the congested road detected in the travel route.

In the travel support control device for a hybrid vehicle according to the second aspect of the disclosure, when an adjustment target road in which a state of charge of the battery needs to be actively adjusted such as a congested road or a downhill road has been detected in the travel route, state-of-charge adjustment control is performed up to the adjustment target road based on look-ahead information generated for the travel route from the current location to the destination. The state-of-charge adjustment control is control in which the state of charge SOC of the battery is increased to a start point of a congested road when the congested road has been detected as the adjustment target road and is control in which the state of charge SOC of the battery is decreased to a start point of a downhill road when the downhill road has been detected as the adjustment target road. An adjustment target road is detected based on look-ahead information generated for an estimated route on which it is estimated that the hybrid vehicle is to travel when a travel route has not been set, and state-of-charge adjustment control is performed up to the adjustment target road when the adjustment target road has been detected. At this time, the target state of charge of the battery at the start point of a congested road in the state-of-charge adjustment control for the congested road detected in the estimated route may be different from the target state of charge of the battery at the start point of a congested road in the state-of-charge adjustment control for the congested road detected in the travel route. Accordingly, it is possible to perform control corresponding to the congested road detected in the travel route or the congested road detected in the estimated route. As a result, it is possible to perform more appropriate control for a congested road or a downhill road in the estimated route.

In the travel support control device for a hybrid vehicle according to the second aspect of the disclosure, the target state of charge of the battery at the start point of a congested road in the state-of-charge adjustment control for the congested road detected in the estimated route may be less than the target state of charge of the battery at the start point of a congested road in the state-of-charge adjustment control for the congested road detected in the travel route. With this configuration, it is possible to perform control corresponding to a congested road detected in the travel route or a congested road detected in the estimated route.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of a travel support control device for a hybrid vehicle 20 according to an embodiment of the disclosure with a hybrid ECU 50 as a central block;

FIG. 2 is a flowchart illustrating an example of travel support control which is performed by the hybrid ECU 50;

FIG. 3 is a flowchart illustrating an example of a look-ahead information generating and transmitting process which is performed by a navigation system 80; and

FIG. 4 is a flowchart illustrating an example of a travel support plan creating process which is performed by the hybrid ECU 50.

### DETAILED DESCRIPTION OF EMBODIMENTS

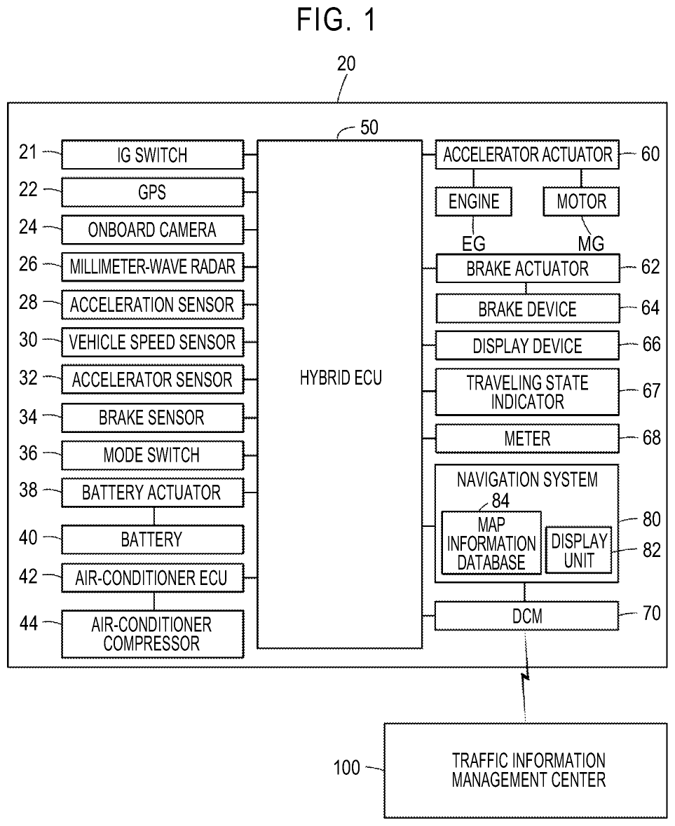

Hereinafter, a mode for carrying out the disclosure will be described with reference to an embodiment. FIG. 1 is a block diagram illustrating an example of a configuration of a travel support control device for a hybrid vehicle 20 according to an embodiment of the disclosure with a hybrid electronic control unit (hereinafter referred to as a hybrid ECU) 50 as a central block. The electronic control unit 50 corresponds to the travel support control device. The hybrid vehicle 20 according to the embodiment includes an engine EG and a motor MG as power sources as illustrated in the drawing. The hybrid vehicle 20 according to the embodiment travels while switching a travel mode between a charge depleting mode (a CD mode) in which electric traveling has priority such that a state of charge SOC of a battery 40 decreases and a charge sustaining mode (a CS mode) in which electric traveling and hybrid traveling are used together such that the state of charge SOC of the battery 40 is maintained at a target value. Electric traveling is a mode in which the hybrid vehicle travels using only power from the motor MG in a state in which operating of the engine EG has been stopped, and hybrid traveling is a mode in which the engine EG operates and the hybrid vehicle travels using power from the engine EG and power from the motor MG.

The hybrid vehicle 20 according to the embodiment includes an ignition switch 21, a Global Positioning System (Global Positioning Satellite) (GPS) unit 22, an onboard camera 24, a millimeter-wave radar 26, an acceleration sensor 28, a vehicle speed sensor 30, an accelerator sensor 32, a brake sensor 34, a mode switch 36, a battery actuator 38, a battery 40, an air-conditioner electronic control unit (hereinafter referred to as an air-conditioner ECU) 42, an air-conditioner compressor 44, a hybrid ECU 50, an accelerator actuator 60, a brake actuator 62, a brake device 64, a display device 66, a traveling state indicator 67, a meter 68, a data communication module (DCM) 70, and a navigation system 80 in addition to the power sources.

The GPS unit 22 is a device that detects a position of a vehicle based on signals transmitted from a plurality of GPS satellites. The onboard camera 24 is a camera that images surroundings of the vehicle and corresponds to, for example, a front-view camera that images a front view of the vehicle or a rear-view camera that images a rear view of the vehicle. The millimeter-wave radar 26 detects an inter-vehicle distance or a relative speed between the host vehicle and a front vehicle or detects an inter-vehicle distance or a relative speed between the host vehicle and a rear vehicle.

The acceleration sensor 28 is, for example, a sensor that detects an acceleration in a longitudinal direction of the vehicle or detects an acceleration in a right-left direction (a lateral direction) of the vehicle. The vehicle speed sensor 30 detects a vehicle speed of the vehicle based on wheel speeds or the like. The accelerator sensor 32 detects an accelerator operation amount or the like corresponding to an amount of depression of an accelerator pedal by a driver. The brake sensor 34 detects a brake position or the like which is an amount of depression of a brake pedal by the driver. The mode switch 36 is a switch that is provided in the vicinity of a steering wheel in a driver's seat and switches between a CD mode and a CS mode.

The battery actuator 38 detects conditions such as an inter-terminal voltage, a charging/discharging current, and a battery temperature of the battery 40 and manages the battery 40 based on the results of detection. The battery actuator 38 calculates a state of charge SOC which is a ratio of a residual storage capacity to a full storage capacity based on the charging/discharging current or calculates an allowable maximum output electric power (an output limit Wout) which may be output from the battery 40 or an allowable maximum input electric power (an input limit Win) which may be input to the battery 40 based on the state of charge SOC, the battery temperature, and the like. The battery 40 is configured as a rechargeable secondary battery and, for example, a lithium ion battery, a nickel-hydride battery, or a lead storage battery can be used.

The air-conditioner ECU 42 is configured as a microcomputer that is not illustrated but includes a CPU as a major constituent, and includes a ROM, a RAM, a flash memory, an input port, an output port, and a communication port in addition to the CPU. The air-conditioner ECU 42 is assembled into an air conditioner that conditions air of a cabin and controls driving of the air-conditioner compressor 44 in the air conditioner such that the temperature of the cabin reaches a set temperature.

The engine EG is configured as, for example, an internal combustion engine. The motor MG is configured as, for example, an electric motor that also serves as a power generator such as a synchronous generator motor. The motor MG is connected to the battery 40 via an inverter which is not illustrated and can output a driving force using electric power supplied from the battery 40 or charge the battery 40 with electric power generated therein.

The hybrid ECU 50 is configured as a microcomputer that is not illustrated but includes a CPU as a major constituent, and includes a ROM, a RAM, a flash memory, an input port, an output port, and a communication port in addition to the CPU. The hybrid ECU 50 sets a travel mode or sets a target operating point (a target rotation speed or a target torque) of the engine EG or a torque command for the motor MG based on the set travel mode, the accelerator operation amount from the accelerator sensor 32, the brake position from the brake sensor 34, and the output limit and the input limit from the battery actuator 38. The hybrid ECU 50 is not started in an accessory-on state but is started in a ready-on state.

In electric traveling, the hybrid ECU 50 sets a required driving force or a required power based on the accelerator operation amount from the accelerator sensor 32 or the vehicle speed from the vehicle speed sensor 30, sets a torque command for the motor MG such that the required driving force or the required power is output to the vehicle, and transmits the set torque command to the accelerator actuator 60. In hybrid traveling, the hybrid ECU 50 sets a target operating point for the engine EG and a torque command for the motor MG such that the required driving force or the required power is output to the vehicle, and transmits the target operating point and the torque command to the accelerator actuator 60. When the brake pedal is depressed, the hybrid ECU 50 sets a required braking force based on the brake position from the brake sensor 34 or the vehicle speed from the vehicle speed sensor 30, sets a regenerative torque command for controlling regeneration of the motor MG based on the required braking force or the vehicle speed, sets a target braking force from a brake device, transmits the torque command to the accelerator actuator 60, and transmits the target braking force to the brake actuator 62.

The accelerator actuator 60 controls driving of the engine EG or the motor MG based on the target operating point or the torque command set by the hybrid ECU 50. The accelerator actuator 60 performs intake air amount control, fuel injection control, ignition control, intake valve opening/closing timing control, and the like such that the engine EG operates at the target operating point (a target rotation speed or a target torque). The accelerator actuator 60 controls switching of switching elements of the inverter for driving the motor MG such that a torque corresponding to the torque command is output from the motor MG.

The brake actuator 62 controls the brake device 64 such that the target braking force set by the hybrid ECU 50 is applied to the vehicle by the brake device 64. The brake device 64 is configured as, for example, a hydraulic frictional brake.

The display device 66 is assembled into, for example, an instrument panel in front of a driver's seat and displays various types of information. The traveling state indicator 67 includes an EV indicator and an HV indicator which are not illustrated, turns on the EV indicator and turns off the HV indicator in electric traveling, and turns off the EV indicator and turns on the HV indicator in hybrid traveling. The meter 68 is assembled into, for example, the instrument panel in front of the driver's seat.

The DCM 70 transmits information of the host vehicle to a traffic information management center 100 or receives road traffic information from the traffic information management center 100. Examples of the information of the host vehicle include a position, a vehicle speed, a traveling power, and a travel mode of the host vehicle. Examples of the road traffic information include information on current or future congestion, information on a current average vehicle speed or a predicted value of a future average vehicle speed in sections of a travel route, information on traffic regulations, information on weather, information on road surface conditions, and information on maps. The DCM 70 communicates with the traffic information management center 100 at intervals of a predetermined time (for example, at intervals of 30 seconds, 1 minute, or 2 minutes).

The navigation system 80 is a system that guides the host vehicle to a set destination and includes a display unit 82 and a map information database 84. The navigation system 80 communicates with the traffic information management center 100 via the DCM 70. When a destination is set, the navigation system 80 sets a route based on information of the destination, information of a current location (a current position of the host vehicle) acquired by the GPS unit 22, and information stored in the map information database 84. The navigation system 80 acquires road traffic information by communicating with the traffic information management center 100 at intervals of a predetermined time (for example, at intervals of 3 minutes or 5 minutes), and performs route guidance based on the road traffic information.

In the route guidance, whenever road traffic information is acquired from the traffic information management center 100 (or at intervals of a predetermined time), the navigation system 80 generates load information and the like required for traveling in each travel section as look-ahead information based on information of each travel section or information of a travel load in the travel route out of the road traffic information acquired from the traffic information management center 100, the vehicle speed of the host vehicle, a travel power of the host vehicle, a travel mode of the host vehicle, and the like and transmits the generated look-ahead information to the hybrid ECU 50. The look-ahead information includes information of the host vehicle such as a position, a vehicle speed, a travel power, and a travel mode of the host vehicle, information on current or future congestion, information on a predicted value of a current average vehicle speed or a future average vehicle speed in sections of the travel route, information on traffic regulations, information on weather, information on road surface conditions, and information on maps.

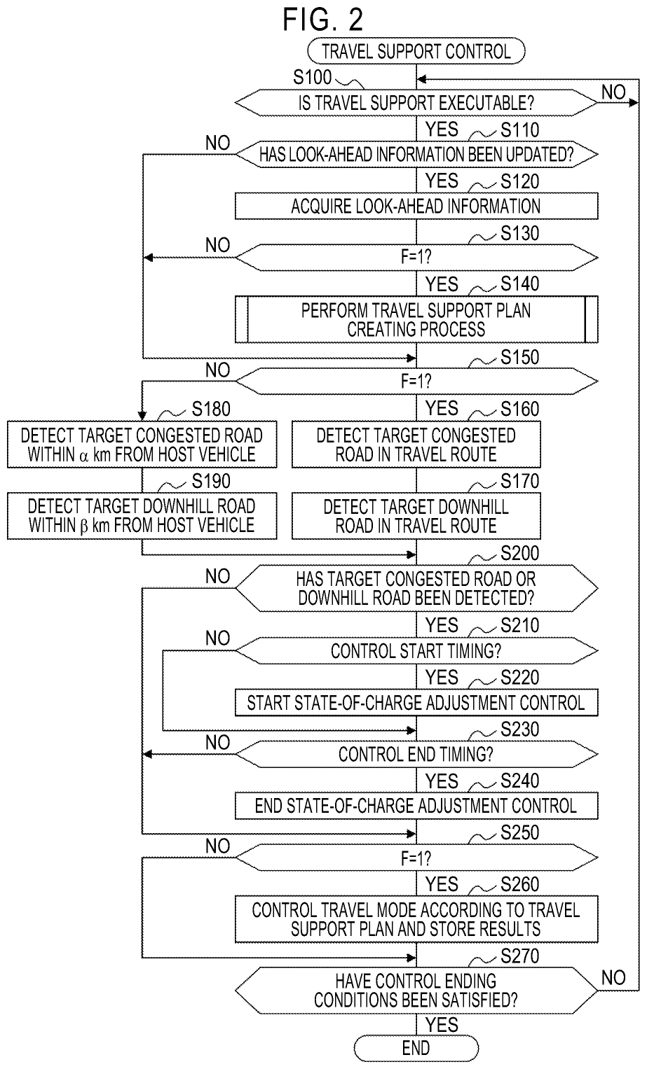

Operations of the hybrid vehicle 20 having the aforementioned configuration will be described below. FIG. 2 is a flowchart illustrating an example of travel support control which is performed by the hybrid ECU 50. This flowchart is performed after the ignition switch 21 has been turned on.

In the travel support control, first, it is determined whether travel support control is executable (Step S100). When route guidance cannot be performed well such as when an abnormality occurs in the navigation system 80 or when an abnormality occurs in the GPS unit 22, the travel support control is not executable. When the battery temperature is low, the output limit Wout which is an allowable maximum output electric power which may be output from the battery 40 decreases, the engine EG may be frequently started even when the host vehicle is traveling in the CD mode, and the host vehicle may not be able to travel appropriately in the CD mode. In Step S100, it is determined whether travel support control is executable due to such circumstances. When it is determined in Step S100 that travel support control is not executable, this routine waits until travel support control becomes executable.

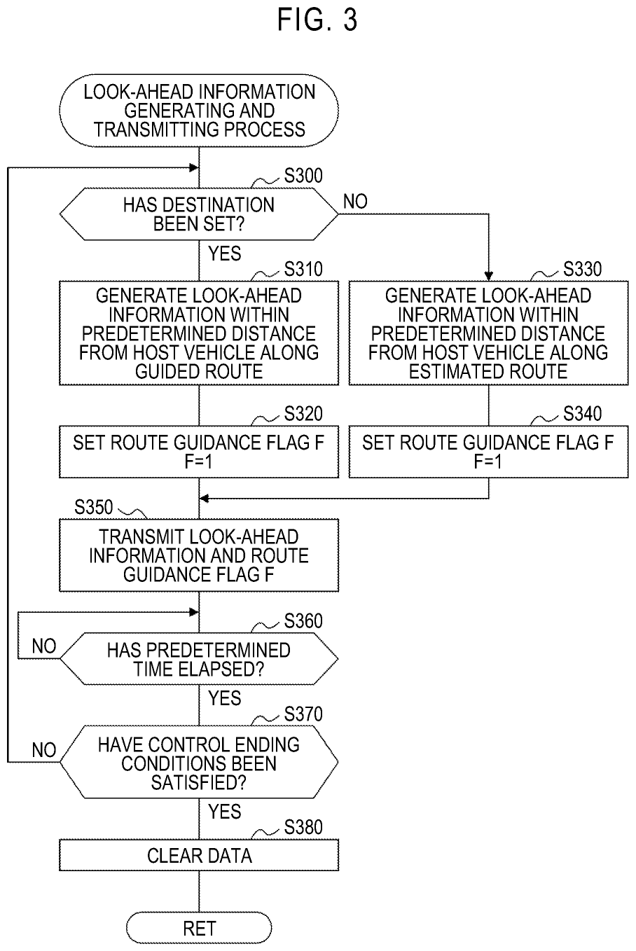

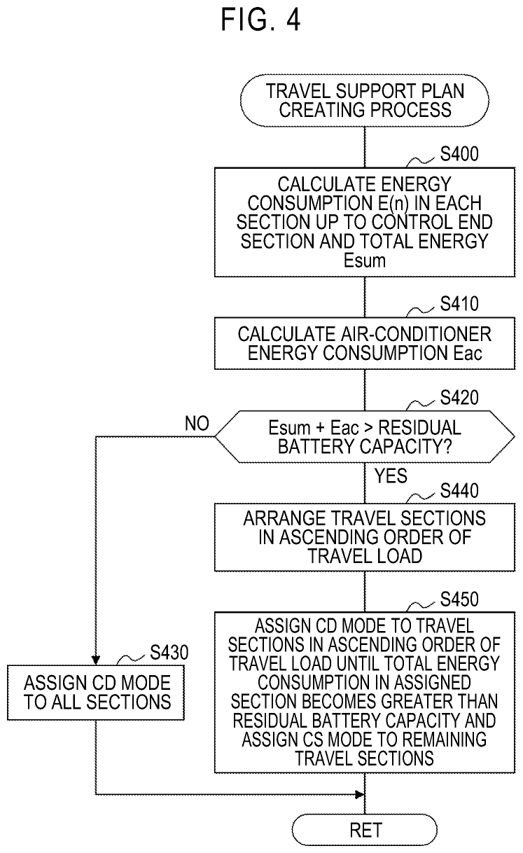

When it is determined in Step S100 that travel support control is executable, it is determined whether look-ahead information transmitted from the navigation system 80 has been updated (Step S110). When it is determined that look-ahead information has been updated, look-ahead information is acquired (Step S120), a value of a route guidance flag F is ascertained (Step S130), and a travel support plan creating process is performed to create a travel support plan when the value of the route guidance flag F is 1, that is, when a destination has been set and a travel route from the current location to the destination has been set (Step S140). The look-ahead information is generated and transmitted through a look-ahead information generating and transmitting process which is performed by the navigation system 80. FIG. 3 illustrates an example of the look-ahead information generating and transmitting process. FIG. 4 illustrates an example of the travel support plan creating process. Description of the travel support control will be suspended and the look-ahead information generating and transmitting process and the travel support plan creating process will be sequentially described below. Acquisition of look-ahead information or creation of a travel support plan is not performed when it is determined in Step S110 that look-ahead information has not been updated, and creation of a travel support plan is not performed when it is determined in Step S130 that the value of the route guidance flag F is 0.

In the look-ahead information generating and transmitting process illustrated in FIG. 3, first, it is determined whether a destination has been set, that is, whether a travel route from the current location to the destination has been set (Step S300). When it is determined that a destination has been set (a travel route has been set), look-ahead information within a predetermined distance from the host vehicle along the travel route is generated (Step S310), and the value of the route guidance flag F is set to 1 (Step S320). Here, 10 km, 20 km, or the like can be used as the predetermined distance. On the other hand, when it is determined that a destination has not been set (a travel route has not been set), look-ahead information within a predetermined distance from the host vehicle along an estimated route is generated (Step S330), and the value of the route guidance flag F is set to 0 (Step S340). The estimated route is a route on which it is estimated that the hybrid vehicle is to travel in a traveling direction of the host vehicle and may be set, for example, as any route within the predetermined distance from the current location including right and left turns or any route within the predetermined distance in a straight extending direction of a road on which the host vehicle is traveling and any route within the predetermined distance on a road crossing a road on which the host vehicle is traveling. Accordingly, when the host vehicle is traveling on a main road, the estimated route may include a route on the main road and a route within a predetermined distance (for example, 1 km or 2 km) from a crossing of the main road on a road crossing the main road. After a predetermined time has elapsed (Step S360), it is determined whether ending conditions of the travel support control have been satisfied (Step S370). The predetermined time is an interval (for example, 3 minutes or 5 minutes) in which the navigation system 80 acquires road traffic information by communicating with the traffic information management center 100 or a time which is longer than the interval. Examples of the control ending conditions include a condition that the host vehicle has arrived at a destination, a condition that the residual capacity of the battery 40 has changed due to charging or the like, and a condition that the ignition switch 21 has been turned off. When it is determined that the control ending conditions have not been satisfied, the routine returns to the process of determining whether a destination has been set in Step S300. When it is determined that the control ending conditions have been satisfied, data such as the look-ahead information are cleared (Step S380), and this routine ends.

In the travel support plan creating process illustrated in FIG. 4, first, an energy consumption E(n) in each travel section of the travel route from the current location to a control ending section (the destination) and a total energy Esum which is a sum thereof are calculated (Step S400). The energy consumption E(n) in each travel section can be determined based on criteria such as whether the travel section is an urban section, a suburban section, or a mountainous section. Then, air-conditioner energy consumption Eac is calculated (Step S410). In this embodiment, the air-conditioner energy consumption Eac is calculated by multiplying a power consumption of an air conditioner at that time, a predetermined power consumption, a maximum power consumption of the air conditioner, or the like by a predetermined time (a time required for traveling 10 km or 15 km). Then, it is determined whether the sum of the total energy Esum and the air-conditioner energy consumption Eac is greater than the residual capacity of the battery 40 (Step S420). The residual capacity of the battery 40 can be calculated by multiplying the full capacity of the battery 40 by the state of charge SOC. When it is determined that the sum of the total energy Esum and the air-conditioner energy consumption Eac is equal to or less than the residual capacity of the battery 40, the CD mode is assigned to all travel sections (Step S430). When it is determined that the sum of the total energy Esum and the air-conditioner energy consumption Eac is greater than the residual capacity of the battery 40, the travel sections are arranged in the ascending order of a travel load (an average load in each section) (Step S440), and the CD mode is assigned to the travel sections until the sum of the energy consumption En in the travel sections assigned in the ascending order of the travel load becomes greater than the residual capacity of the battery 40 and the CS mode is assigned to the remaining travel sections (Step S450). That is, the CD mode and the CS mode are assigned to the travel route based on the premise that the sum of the total energy Esum and the air-conditioner energy consumption Eac is greater than the residual capacity of the battery 40.

Description will be made with reference back to the travel support control illustrated in FIG. 2 below. After the processes of Steps S110 to S140 have been performed, the value of the route guidance flag F is ascertained (Step S150). When the value of the route guidance flag F is 1 (when a travel route has been set), a target congested road or a target downhill road in the travel route is detected based on look-ahead information (Steps S160 or S170). The target congested road may be a travel road in which an average vehicle speed is equal to or less than a threshold vehicle speed (for example, 10 km or 15 km) and is maintained over a threshold distance (for example, 1 km or 2 km) or more. The target downhill road may be a travel road in which a downhill gradient is equal to or greater than a threshold gradient (for example, 2% or 3%) and is maintained over a threshold distance (for example, 1 km or 2 km) or more. On the other hand, when it is determined in Step S150 that the value of the route guidance flag F is 0 (when a travel route has not been set), a target congested road within a first predetermined distance α km from the host vehicle is detected along an estimated route on which it is estimated that the host vehicle is to travel based on look-ahead information (Step S180), and a target downhill road within a second predetermined distance β km from the host vehicle is detected (Step S190). For example, 5 km or 10 km can be used as the first predetermined distance α and, for example, 10 km or 15 km can be used as the second predetermined distance β. In the embodiment, the first predetermined distance α is set to be less than the second predetermined distance β, that is, a detection range of a target congested road when the value of the route guidance flag F is 0 (when a travel route has not been set) is set to be narrower than a detection range of a target downhill road. This is based on the following reasons. State-of-charge adjustment control for a target congested road is control in which the frequency in which the engine EG operates is increased to increase the state of charge SOC of the battery 40. The host vehicle may not travel on the target congested road when the host vehicle does not travel along the estimated route. In this case, a driver may feel discomfort because the engine EG is unnecessarily operated. The detection range of a target congested road in the estimated route is narrowed for the purpose of curbing the frequency in which a driver feels discomfort. The detection range of a congested road in the travel route is a range of the look-ahead information and thus is broader than the detection range of a congested road in the estimated route. The reason thereof is the same.

Subsequently, it is determined whether a target congested road or a target downhill road has been detected (Step S200). When it is determined that a target congested road or a target downhill road has been detected, state-of-charge adjustment control is started after a control start timing has come (Steps S210 and S220). A timing a predetermined distance (for example, 3 km or 5 km, or 10 km) prior to a target congested road or a target downhill road can be used as the control start timing. In this case, the control start timing may be set to differ depending on a target congested road or a target downhill road, or the control start timing may be set to differ depending on whether a travel route has been set or not. In case of a target congested road, control for increasing the state of charge SOC of the battery 40, for example, control for causing the state of charge SOC of the battery 40 at a start point of the target congested road to reach a predetermined target SOC (such as 75% or 80%) can be used as the state-of-charge adjustment control. It is preferable that the target SOC when a destination has not been set be less than that when a destination has been set (when a travel route has been set). This is based on the following reasons. When a travel route has not been set, the host vehicle may not travel on a target congested road in an estimated route. In this case, a driver may feel discomfort due to unnecessary operation of the engine EG in the state-of-charge adjustment control. By setting the target SOC in a target congested road of the estimated route to be less than the target SOC of a congested road in the travel route, it is possible to reduce a degree of discomfort given to a driver. In case of a target downhill road, control for decreasing the state of charge SOC of the battery 40, for example, control for causing the state of charge SOC of the battery 40 at a start point of the target downhill road to reach a predetermined target SOC (such as 30% or 35%) can be used as the state-of-charge adjustment control. When the state-of-charge adjustment control is started, the state-of-charge adjustment control ends after a control end timing has come (Steps S230 and S240). A timing at which the host vehicle reaches a start point of a target congested road or a target downhill road or a timing at which the state of charge SOC of the battery 40 reaches a target value can be used as the control end timing. When it is determined that a target congested road or a target downhill road has not been detected, the state-of-charge adjustment control is not performed.

After the processes of Steps S200 to S240 have been performed, the value of the route guidance flag F is ascertained (Step S250). When it is determined that the value of the route guidance flag F is 1, the travel mode is controlled based on the travel support plan and results of the travel support control (control results) are accumulated (Step S260). When the state-of-charge adjustment control is performed, the state-of-charge adjustment control is performed with a priority higher than the travel mode based on the travel support plan. Examples of the control results include a traveling distance or a traveling time by electric traveling in the travel support control and a traveling distance or a traveling time by hybrid traveling. When the host vehicle arrives at the destination, the accumulated control results are stored in a flash memory or the like which is not illustrated in the hybrid ECU 50 and are notified of by displaying “electric traveling XX km, hybrid traveling YY km” on the display device 66 assembled into the instrument panel in front of the driver's seat. When it is determined in Step S250 that the value of the route guidance flag F is 0, a travel support plan has not been created yet and thus control of the travel mode based on the travel support plan is not performed.

Then, it is determined whether control ending conditions have been satisfied (Step S270). When it is determined that the control ending conditions have not been satisfied, the routine returns to the process of determining whether the travel support control is executable in Step S100. When it is determined that the control ending conditions have been satisfied, the travel support control ends. When the residual capacity of the battery 40 has changed due to charging or the like, the travel support control ends. When new travel support control is started, this routine is performed again.

A case in which a destination has been set and a travel route from a current location to the destination has been set is considered. In this case, through the travel support control, look-ahead information along the travel route is acquired and a travel support plan is created based on the look-ahead information whenever look-ahead information is updated (Steps S110 to S140). Subsequently, a target congested road or a target downhill road in the travel route is detected, state-of-charge adjustment control is started at a control start timing when any target road has been detected, and the state-of-charge adjustment control is ended at a control end timing (Steps S200 to S240). When the state-of-charge adjustment control is performed, the state-of-charge adjustment control is performed with a priority higher than the travel mode based on the travel support plan. Until the control start timing has come or after the state-of-charge adjustment control has ended, the travel mode is controlled based on the travel support plan (Step S260). When a target congested road or a target downhill road has not been detected, the state-of-charge adjustment control is not performed and the travel mode is controlled based on the travel support plan (Step S260).

A case in which a destination has not been set (a case in which a travel route to a destination has not been set) is considered. In this case, through the travel support control, look-ahead information along the travel route is acquired and a travel support plan is not created the whenever look-ahead information is updated. Subsequently, a target congested road within the first predetermined distance α from the host vehicle in the estimated route is detected, a target downhill road within the second predetermined distance β is detected, state-of-charge adjustment control is started at a control start timing when any target road has been detected, and the state-of-charge adjustment control is ended at a control end timing (Steps S200 to S240). Until the control start timing has come or after the state-of-charge adjustment control has ended, the host vehicle travels by electric traveling or by HV traveling based on the accelerator operation amount or the vehicle speed. When a target congested road or a target downhill road has not been detected, the state-of-charge adjustment control is not performed and the host vehicle travels by electric traveling or by HV traveling.

In the travel support control device for a hybrid vehicle 20 according to the aforementioned embodiment, when a destination has not been set (when a travel route to a destination has not been set), a target congested road within the first predetermined distance α from the host vehicle and a target downhill road within the second predetermined distance β from the host vehicle are detected based on look-ahead information generated along an estimated route on which it is estimated that the host vehicle is to travel. When a target congested road or a target downhill road has been detected, state-of-charge adjustment control is started at a control start timing and the state-of-charge adjustment control is ended at a control end timing. Accordingly, it is possible to perform more appropriate control for a congested road or a downhill road in an estimated route on which it is estimated that the host vehicle is to travel. Particularly, by setting the detection range (within the first predetermined distance α) when a target congested road is detected to be narrower than the detection range (the range of the look-ahead information) when a target downhill road is detected, it is possible to reduce a feeling of discomfort which is given to a driver due to unnecessary operation of the engine EG which is caused when the host vehicle does not travel on the target congested road. By setting the detection range (within the first predetermined distance α) when a target congested road in an estimated route is detected to be narrower than the detection range (within the second predetermined distance β when a target congested road in a travel route is detected, it is possible to curb a feeling of discomfort which is given to a driver due to unnecessary operation of the engine EG which is caused when the host vehicle does not travel on the target congested road. The target SOC which is a target value of the state of charge SOC of the battery 40 at a start point of a target congested road in the estimated route is set to be less than the target SOC which is a target value of the state of charge SOC of the battery 40 at a start point of a target congested road in the travel route. Accordingly, it is possible to reduce a degree of discomfort which is given to a driver due to state-of-charge adjustment control when the host vehicle does not travel on the target congested road in the estimated route.

In the hybrid vehicle 20 according to the embodiment, the navigation system 80 sets a travel route from a current location to a destination using the map information database 84 based on information of the current location and information of the destination, but may set the travel route from the current location to the destination in cooperation with the traffic information management center 100. That is, the navigation system 80 may set a travel route by transmitting information of a current location and information of a destination to the traffic information management center 100 and receiving the travel route set based on the information of the current location and the information of the destination by the traffic information management center 100 from the traffic information management center 100.

In the travel support control device for a hybrid vehicle 20 according to the embodiment, the travel support control is performed by the hybrid vehicle traveling according to a travel support plan in which the travel modes including the CD mode and the CS mode are assigned to travel sections of a travel route from a current location to a destination by creating the travel support plan, but such a travel support plan may not be created. That is, the travel support control device may have only to be applied to a configuration in which a travel route from a current location to a destination can be set.

Correspondence between principal elements in the embodiment and principal elements of the disclosure described in the SUMMARY will be described below. In the embodiment, the engine EG corresponds to an “engine,” the motor MG corresponds to a “motor,” the battery 40 corresponds to a “battery,” and the hybrid ECU 50 corresponds to a “travel support control device.”

Since the embodiment is an example for specifically describing the mode for carrying out the disclosure described in the SUMMARY, the correspondence between principal elements in the embodiment and principal elements of the disclosure described in the SUMMARY does not limit elements of the disclosure described in the SUMMARY That is, the disclosure described in the SUMMARY should be construed based on description in the SUMMARY, and the embodiment is only a specific example of the disclosure described in the SUMMARY.

While the mode for carrying out the disclosure has been described above with reference to the embodiment, the disclosure is not limited to the embodiment and can be modified in various forms without departing from the gist of the disclosure.

The disclosure is applicable to industry for manufacturing travel support control devices for a hybrid vehicle.

What is claimed is:

1. A travel support control device for a hybrid vehicle including an engine, a motor, a battery, and a navigation system that performs route guidance for a travel route from a current location to a destination, the travel support control device performing state-of-charge adjustment control up to an adjustment target road in which a state of charge of the battery needs to be actively adjusted such as a congested road or a downhill road when the adjustment target road has been detected in the travel route based on look-ahead information generated for the travel route,
wherein the travel support control device is configured to detect the adjustment target road based on look-ahead information generated for an estimated route on which it is estimated that the hybrid vehicle is to travel when the travel route has not been set and to perform the state-of-charge adjustment control up to the adjustment target road when the adjustment target road has been detected, and
wherein a detection range for detecting a congested road and a detection range for detecting a downhill road in the estimated route are different.

2. The travel support control device for a hybrid vehicle according to claim 1, wherein the detection range for detecting a congested road in the estimated route is narrower than the detection range for detecting a downhill road in the estimated route.

3. The travel support control device for a hybrid vehicle according to claim 1, wherein a target state of charge of the battery at a start point of a congested road in the state-of-charge adjustment control for the congested road detected in the estimated route is different from the target state of charge of the battery at the start point of a congested road in the state-of-charge adjustment control for the congested road detected in the travel route.

4. The travel support control device for a hybrid vehicle according to claim 3, wherein the target state of charge of the battery at the start point of a congested road in the state-of-charge adjustment control for the congested road detected in the estimated route is less than the target state of charge of the battery at the start point of a congested road in the state-of-charge adjustment control for the congested road detected in the travel route.

5. A travel support control device for a hybrid vehicle including an engine, a motor, a battery, and a navigation system that performs route guidance for a travel route from a current location to a destination, the travel support control device performing state-of-charge adjustment control up to an adjustment target road in which a state of charge of the battery needs to be actively adjusted such as a congested road or a downhill road when the adjustment target road has been detected in the travel route based on look-ahead information generated for the travel route,
wherein the travel support control device is configured to detect the adjustment target road based on look-ahead information generated for an estimated route on which it is estimated that the hybrid vehicle is to travel when the travel route has not been set and to perform the state-of-charge adjustment control up to the adjustment target road when the adjustment target road has been detected, and
wherein a target state of charge of the battery at a start point of a congested road in the state-of-charge adjustment control for the congested road detected in the estimated route is different from the target state of charge of the battery at the start point of a congested road in the state-of-charge adjustment control for the congested road detected in the travel route.

6. The travel support control device for a hybrid vehicle according to claim 5, wherein the target state of charge of the battery at the start point of a congested road in the state-of-charge adjustment control for the congested road detected in the estimated route is less than the target state of charge of the battery at the start point of a congested road in the state-of-charge adjustment control for the congested road detected in the travel route.
